(19) United States
(12) Patent Application Publication
(10) Pub. No.: US 2026/0154227 A1
(43) Pub. Date: Jun. 4, 2026

(54) Virtualized PTM Master Time

(71) Applicant: Mellanox Technologies, Ltd., Yokneam (IL)

(72) Inventors: Wojciech Wasko, Mlynek (PL); Natan Manevich, Nesher (IL); Maciej Machnikowski, Reda (PL); Nir Laufer, Zoran (IL); Dotan David Levi, Kiryat Motzkin (IL)

(21) Appl. No.: 18/964,450

(22) Filed: Dec. 1, 2024

(51) Int. Cl. G06F 13/42; G06F 1/14; G06F 13/40

(52) U.S. Cl. CPC G06F 13/4217; G06F 1/14; G06F 13/4022

(57) ABSTRACT

In one embodiment, a responder device is associated with a data communication bus between a host device and a peripheral device, the host device being to execute a virtual machine (VM) and maintain a master clock time, the peripheral device being to execute a virtual function (VF) associated with the VM, and the responder device includes an interface to share data with the peripheral device, and processing circuitry to transform values of the master clock time to a frame of reference of the VM based on a transformation between the master clock time and a virtual counter value of the VM, and perform a time measurement dialogue with the VF including measurement messages exchanged by the responder device and the peripheral device, the measurement messages including translated values of the master clock time in the frame of reference of the VM.

### FIELD OF THE DISCLOSURE

The present disclosure relates to computer systems, and in particular, but not exclusively to, clock measurement.

### BACKGROUND

Peripheral Component Interconnect Express (PCIe) Precision Time Measurement PTM is used as a time offset measurement technology within systems (e.g., between a peripheral device and a root port, e.g., of a host device connected to the peripheral device), replacing legacy, jittery methods to measure time offset between different devices in the system. PCIe PTM is an optional feature within the PCIe specification that provides a common “PTM master time”. The PTM master time serves like a common ruler, allowing different devices in a PCIe system to measure the offset of their local time with respect to the PTM master time. The PTM master time is disseminated from the PTM Root which is typically implemented inside the PCIe Root Port.

The PTM measurement is basically a simultaneous snapshot of the PTM master time and the peripheral device's local time/counter value. The PTM measurement is obtained by the peripheral device exchanging some PCIe messages with its upstream link partner (e.g., a PTM request from the peripheral device towards the link partner and a PTM Response/ResponseD from the link partner towards the peripheral device). Once the data is available, an equation specified in the PCIe base specification can be applied to calculate a pair of two simultaneous snapshots of the device's clock and the PTM master time. The peripheral device either provides raw data or the results of the equation to software which can then discipline a clock, or clocks as needed.

There is often a known, fixed relation between the PTM master time and a counter that is used to construct central processor unit (CPU) and/or software clocks (e.g., a Time Stamp Counter (TSC) in x86 architectures or CNTPCT_EL0 (System Counter) in ARM architectures). An oscillator provides a frequency source for the PTM master time. The oscillator may also provide the frequency source for the CPU counter. The CPU counter may also start at boot but may run at its own frequency (e.g., at a multiple or fraction of the oscillator frequency). Thus, the fixed relation may be used by the CPU to translate the measurements from “(PTM master time value; device time value)” to “(CPU counter value; device time value)”.

### Overview

There is provided in accordance with an embodiment of the present disclosure, a responder device associated with a data communication bus between a host device and a peripheral device, the host device being to execute a virtual machine (VM) and maintain a master clock time, the peripheral device being to execute a virtual function (VF) associated with the VM, the responder device including an interface to share data with the peripheral device, and processing circuitry to transform values of the master clock time to a frame of reference of the VM based on a transformation between the master clock time and a virtual counter value of the VM, and perform a time measurement dialogue with the VF including measurement messages exchanged by the responder device and the peripheral device, the measurement messages including translated values of the master clock time in the frame of reference of the VM.

Further in accordance with an embodiment of the present disclosure the host device includes a root port, which includes the responder device, and a master clock to maintain the master clock time.

Still further in accordance with an embodiment of the present disclosure the host device includes a CPU counter, wherein a value of the CPU counter has a given relationship with the master clock time, and a central processing unit (CPU) to run a hypervisor to manage the VM, provide the virtual counter value of the VM to the VM upon request of the VM based on a given relationship between the value of the CPU counter and the virtual counter value of the VM, wherein the transformation between the master clock time and the virtual counter value of the VM is based on (a) the given relationship between the value of the CPU counter and the master clock time, and (b) the given relationship between the value of the CPU counter and the virtual counter value, and instantiate the VF in the peripheral device.

Additionally in accordance with an embodiment of the present disclosure the data communication bus includes a switch device including the responder device.

Moreover, in accordance with an embodiment of the present disclosure the host device includes a root port, which includes a master clock to maintain the master clock time, a CPU counter, wherein a value of the CPU counter has a given relationship with the master clock time, and a central processing unit (CPU) to run a hypervisor to manage the VM, provide the virtual counter value of the VM to the VM upon request of the VM based on a given relationship between the value of the CPU counter and the virtual counter value of the VM, wherein the transformation between the master clock time and the virtual counter value of the VM is based on (a) the given relationship between the value of the CPU counter and the master clock time, and (b) the given relationship between the value of the CPU counter and the virtual counter value, and instantiate the VF in the peripheral device.

Further in accordance with an embodiment of the present disclosure the VM is to request, from the VF over the data communication bus, timing data derived from the time measurement dialogue, and the VM is to receive the timing data from the VF over the data communication bus.

Still further in accordance with an embodiment of the present disclosure the VF is to provide the timing data to the VM over the data communication bus.

Additionally in accordance with an embodiment of the present disclosure the peripheral device includes a network device, and the VF is a virtual network adapter of the VM.

Moreover in accordance with an embodiment of the present disclosure the host device is to execute a plurality of VMs, the peripheral device is to execute a plurality of VFs corresponding to the plurality of VMs, the processing circuitry is to select from a plurality of transformations between the master clock time and respective virtual counter values of the plurality of VMs, transform values of the master clock time to respective frames of reference of respective ones of the plurality of VMs based on respective ones of the transformations, and perform time measurement dialogues with the plurality of VFs including measurement messages exchanged by the responder device and the peripheral device, the measurement messages including translated values of the master clock time in the respective frames of reference.

Further in accordance with an embodiment of the present disclosure the processing circuitry is to select from the plurality of transformations between the master clock time and the respective virtual counter values of the plurality of VMs based on data included in requests received from the VFs.

Still further in accordance with an embodiment of the present disclosure the data included in the requests includes VF-specific requester identifications (IDs).

Additionally in accordance with an embodiment of the present disclosure the VFs are to generate the requests with the VF-specific requester IDs.

Moreover, in accordance with an embodiment of the present disclosure the host device includes a central processing unit (CPU) to run a hypervisor to manage the VM, the hypervisor being to configure the responder device to apply the transformations to given values of the master clock time the VFs requesting time responses.

Further in accordance with an embodiment of the present disclosure the transformation includes a constant addition/subtraction factor and a constant multiplication/division factor.

There is also provided in accordance with another embodiment of the present disclosure, a system, including a host device to execute a virtual machine (VM) and maintain a master clock time, a data communication bus disposed between the host device and the peripheral device, a peripheral device to execute a virtual function (VF) associated with the VM, and a responder device, including an interface to share data with the peripheral device, and processing circuitry to transform values of the master clock time to a frame of reference of the VM based on a transformation between the master clock time and a virtual counter value of the VM, and perform a time measurement dialogue with the VF including measurement messages exchanged by the responder device and the peripheral device, the measurement messages including translated values of the master clock time in the frame of reference of the VM.

Still further in accordance with an embodiment of the present disclosure the host device includes a root port, which includes the responder device, and a master clock to maintain the master clock time.

Additionally in accordance with an embodiment of the present disclosure the host device includes a CPU counter, wherein a value of the CPU counter has a given relationship with the master clock time, and a central processing unit (CPU) to run a hypervisor to manage the VM, provide the virtual counter value of the VM to the VM upon request of the VM based on a given relationship between the value of the CPU counter and the virtual counter value of the VM, wherein the transformation between the master clock time and the virtual counter value of the VM is based on (a) the given relationship between the value of the CPU counter and the master clock time, and (b) the given relationship between the value of the CPU counter and the virtual counter value, and instantiate the VF in the peripheral device.

Moreover, in accordance with an embodiment of the present disclosure, the system includes a data communication bus switch device including the responder device.

Further in accordance with an embodiment of the present disclosure the host device includes a root port, which includes a master clock to maintain the master clock time, a CPU counter, wherein a value of the CPU counter has a given relationship with the master clock time, and a central processing unit (CPU) to run a hypervisor to manage the VM, provide the virtual counter value of the VM to the VM upon request of the VM based on a given relationship between the value of the CPU counter and the virtual counter value of the VM, wherein the transformation between the master clock time and the virtual counter value of the VM is based on (a) the given relationship between the value of the CPU counter and the master clock time, and (b) the given relationship between the value of the CPU counter and the virtual counter value, and instantiate the VF in the peripheral device.

Still further in accordance with an embodiment of the present disclosure the VM is to request, from the VF over the data communication bus, timing data derived from the time measurement dialogue, and the VM is to receive the timing data from the VF over the data communication bus.

Additionally in accordance with an embodiment of the present disclosure the VF is to provide the timing data to the VM over the data communication bus.

Moreover, in accordance with an embodiment of the present disclosure the peripheral device includes a network device, and the VF is a virtual network adapter of the VM.

Further in accordance with an embodiment of the present disclosure the host device is to execute a plurality of VMs, the peripheral device is to execute a plurality of VFs corresponding to the plurality of VMs, the processing circuitry is to select from a plurality of transformations between the master clock time and respective virtual counter values of the plurality of VMs, transform values of the master clock time to respective frames of reference of respective ones of the plurality of VMs based on respective ones of the transformations, and perform time measurement dialogues with the plurality of VFs including measurement messages exchanged by the responder device and the peripheral device, the measurement messages including translated values of the master clock time in the respective frames of reference.

Still further in accordance with an embodiment of the present disclosure the processing circuitry is to select from the plurality of transformations between the master clock time and the respective virtual counter values of the plurality of VMs based on data included in requests received from the VFs.

Additionally in accordance with an embodiment of the present disclosure the data included in the requests includes VF-specific requester identifications (IDs).

Moreover, in accordance with an embodiment of the present disclosure the VFs are to generate the requests with the VF-specific requester IDs.

Further in accordance with an embodiment of the present disclosure the host device includes a central processing unit (CPU) to run a hypervisor to manage the VM, the hypervisor being to configure the responder device to apply the transformations to given values of the master clock time the VFs requesting time responses.

Still further in accordance with an embodiment of the present disclosure the transformation includes a constant addition/subtraction factor and a constant multiplication/division factor.

There is also provided in accordance with still another embodiment of the present disclosure a method, including sharing data with a peripheral device over a data communication bus between a host device and a peripheral device, transforming values of a master clock time maintained by the host device to a frame of reference of a virtual machine (VM) executed by the host device based on a transformation between the master clock time and a virtual counter value of the VM, and performing a time measurement dialogue with a VF associated with the VM, the VF being executed by the peripheral device, the time measurement dialogue including measurement messages exchanged by a responder device and the peripheral device, the measurement messages including translated values of the master clock time in the frame of reference of the VM.

### BRIEF DESCRIPTION OF THE DRAWINGS

The present disclosure will be understood from the following detailed description, taken in conjunction with the drawings in which:

FIG. 1 is a block diagram view a clock measurement system constructed and operative in accordance with an embodiment of the present disclosure;

FIG. 2 is a data flow diagram showing example time measurement dialogues in the system of FIG. 1;

FIG. 3 is a flowchart including steps in a method performed by a CPU of a host device in the system of FIG. 1;

FIG. 4 is a block diagram view of a responder device of the system of FIG. 1.

FIG. 5 is a flowchart including steps in a method performed by the responder device of FIG. 4;

FIG. 6 is a flowchart including steps in a method performed by a virtual machine and a virtual function in the system of FIG. 1; and

FIG. 7 is a block diagram that schematically illustrates a computing system, e.g., a data center or a High-Performance Computing (HPC) cluster, in accordance with an embodiment of the present disclosure.

### DESCRIPTION OF EXAMPLE EMBODIMENTS

### Overview

As previously mentioned, Peripheral Component Interconnect Express (PCIe) Precision Time Measurement PTM is used as a time offset measurement technology within systems (e.g., between a peripheral device and a root port, e.g., of a host device connected to the peripheral device), replacing legacy, jittery methods to measure time offset between different devices in the system. However, naïve application of PCIe PTM in virtualized environments leaks information about the underlying HW platform to unprivileged software (such as virtual machines) which can have unintended consequences.

Some problems with PTM & virtualization are now described.

First, a virtual machine does not know the relationship between PTM master time and virtual machine (VM) time (e.g., VM CPU counter value) due to the CPU counter either being entirely virtualized (i.e., when the VM reads the register that it believes to contain the CPU counter value, this read is trapped and emulated with the response (counter value) produced by Hypervisor software), and/or due to use of CPU counter scaling/offset functionality (i.e., when the VM reads the register containing the CPU counter value, the response comes from the physical CPU counter but before the value is returned, it is offset and scaled by the CPU hardware according to parameters pre-programmed in the CPU hardware by the Hypervisor software).

CPU counter value emulation of scaling and/or offset is performed to “hide” from the unprivileged agents (e.g., Virtual Machines) the information about the physical system that the VMs are running on. For example, a virtual machine can be migrated between different physical machines. If the CPU counter value exposed to the virtual machine is the raw physical counter value of the CPU counter, the virtual machine could observe discontinuities and glitches in the values reported to the virtual machine as the virtual machine is being migrated, and thereby infer information from the values that the VM should not have access to or suffer a malfunction as many applications assume that there are no discontinuities of time and will behave incorrectly if time jumps, especially backwards. To prevent discontinuities from occurring, when a VM is migrated from one physical system to another, hypervisor software of the target system typically configures TSC virtualization appropriately so that when the VM is restarted, the TSC appears contiguous to the VM.

As previously mentioned, the PTM master time and TSC can derive from the same oscillation source. In bare-metal hardware, the relation between PTM master time and the TSC counter can be established because the TSC frequency and/or phase difference is known. However, for Virtual Machines, the TSC scaling & offset are not known to the VMs; instead, they are controlled by the Hypervisor.

Second, when the peripheral device attached to the Virtual Machine reports PCIe PTM measurements, it exposes the value of the PTM master time, which is a physical counter, thus exposing information about the underlying physical system. This can be used to detect whether a Virtual Machine was suspended or migrated (it would appear as one or more discontinuities in PTM master time values over time).

Single root I/O virtualization (SR-IOV) is a PCIe device virtualization standard. It allows a single physical PCIe device to be shared directly among multiple virtual machines (VMs) without the need for hypervisor intervention in the data path. A hypervisor is a privileged software running unvirtualized on the host CPU. The hypervisor manages the physical resources and VMs. In the context of SR-IOV, the hypervisor sets up and allocates Virtual Functions (VFs) for VMs, establishing the mapping between VFs and VMs.

A physical Function (PF) represents the main functionality of the PCIe device and acts as a manager for the SR-IOV capability, enabling and controlling the VFs. A Virtual Function (VF) is a lightweight PCIe function created by the PF and provides the input/output (I/O) resources and interfaces that VMs can directly use, essentially giving VMs “direct” access to parts of the physical PCIe device. VMs do not directly interact with the PF, instead, they interface with VFs. Each VM typically has its own unique VF, allowing direct, efficient, and isolated access to the resources of the PCIe device.

In an SR-IOV enabled setup, the hypervisor's main task is the initial configuration and allocation of VFs to VMs. Once allocated, the VMs interact with these VFs as if the VFs were dedicated hardware devices, enhancing performance by bypassing the traditional virtualization data path that involves the hypervisor.

As mentioned above, in virtualized systems, when a VM requests its virtual counter value, the CPU counter value is scaled and/or offset by the CPU to provide the virtual counter value. Due to the VM not knowing the transformation between the CPU counter and its virtual counter, the VM does not know the relationship between its time and the PTM master time. If the VM were to ask the peripheral device to supply the latest PTM dialogues between peripheral device and PCIe root port, for example, the peripheral device would provide the raw PTM master time timestamp. First, providing the raw PTM master time timestamp may be viewed as a security breach, but it also makes PTM unusable, as even if the PTM dialogues were supplied to the VM, the VM could not do anything with the dialogues as the VM does not know the translation parameters between PTM master and its own time.

For example, the CPU could request the latest PTM dialogues from the peripheral device. The peripheral device would return the peripheral device time at time t, and the corresponding PTM master time at time t. As the CPU (or hypervisor) knows the relationship between the PTM master time and its own time, the CPU (or hypervisor) can use the received values, e.g., to synchronize between the CPU clock and the peripheral device clock. The VM, on the other hand, cannot do this as the VM does not know its relationship with the PTM master time.

One solution to the above drawbacks, is to provide a device in which the CPU (e.g., by the hypervisor running on the CPU) provides the translation parameters (e.g., constant offset addition and/or multiplication by a value) between the PTM master time and the virtual counter value of a VM to the peripheral device so that the peripheral device may translate any PTM master time value to the frame of reference of the VM using the translation parameters. The peripheral device may then provide the PTM master time value(s) in the frame of reference of the VM to the VM. The hypervisor may provide the translation parameters to a virtual function (VF) of the VM so that the VF may translate any PTM master time value to the frame of reference of the VM using the translation parameters. The VF may then provide the PTM master time value(s) in the frame of reference of the VM to the VM. The above necessitates making changes to the functioning of the peripheral device, by the hypervisor, for example.

Embodiments of the present disclosure, address at least some of the above drawbacks by configuring a responder device in the PCIe-PTM protocol (e.g., the root port of the host device or a PCIe switch) to transform values of the PTM master time to a frame of reference of the relevant VM when performing a time dialogue with the VF executed by the peripheral device. Therefore, when the VM requests time dialogue data from the VF, the values of the PTM master time included in the time dialogue data are already in the frame of reference of the requesting VM.

For example, when the VF (i.e., VF1) of VM1 requests the PTM master time, the root port or PCIe switch responds with the PTM master time translated to a frame of reference of VM1. In this way, the PTM dialogue created between VF1 and the root port or PCIe switch already has PTM times translated to the frame of reference of VM1. Therefore, when the dialogue or other time based on the dialogue is requested by VM1, the PTM time data is in the frame of reference of VM1. In the above method the peripheral device does not know, or need to know, about the translation which was performed. The root port or PCIe switch knows that VF1 is associated with VM1 in order to perform the correct translation, for example, when there are multiple VMs being run by the host device.

In some embodiments, the (PTM) responder device (e.g., PTM root port or the PCIe switch) to which the peripheral device is connected applies a transformation (e.g. a constant offset addition and multiplication by a value) to the retrieved/received PTM master time snapshots before the PTM master time snapshots are returned to the PTM requester in PTM ResponseD messages.

In some embodiments, the transformation is software-programmable, and the hypervisor running on the host device exposes configuration parameters (which define the transformations to be applied to the PTM master time) to the PTM Root or the PCIe switch to which the peripheral device is connected. When the hypervisor is running multiple VMs, each VM may have its own associated transformation to translate PTM master time to the frame of reference of that VM. The responder device (i.e., the PTM Root, or the PCIe switch to which the peripheral device is connected) selectively applies different transformations to the PTM master time based on the identity of the VF requesting the time values. In some embodiments, the identity of VF requesting the time value(s) is encoded in the Requester ID of the PTM request/Response message. The requester ID identifies the PF or VF.

In some embodiments, the hypervisor exposes multiple configuration parameters for different VFs enumerated on the PCIe bus. The hypervisor (e.g., when it instantiates the VMs) programs the transformation parameters for responding to a given VF in the PTM Root or the PCIe switch (to which the peripheral device is connected) based on the characteristics of the virtual CPU counter exposed to the virtual machine to which that particular VF is attached, e.g. instructing the PTM Root or the PCIe switch (to which the peripheral device is connected) to scale and offset the PTM master time by the same parameters by which the virtual CPU counter is scaled and offset from the physical CPU counter.

In some embodiments, the peripheral device returns timestamps of the PTM messages (transformed to the frame of reference of the VM by the responder device) as well as the values communicated from the PTM Root (reception timestamp and propagation delay) to the VM. Software running on the VM may apply an equation from the PCIe specification to derive the values of two timestamps.

In other embodiments, the peripheral device returns a pair of simultaneous snapshots of the PTM master time (transformed to the frame of reference of the VM by the responder device) and the peripheral device counter to the VM. Hardware or firmware of the peripheral device applies the equation from the PCIe specification.

The peripheral device may return any suitable timing data to the VM with the PTM master time data transformed to the frame of reference of the VM by the responder device. The timing data may include any one or more of the following: a simultaneous/correlated snapshot of the peripheral device counter and the transformed PTM master time; a difference between the peripheral device counter and the transformed PTM master time; actual data from the PTM messages.

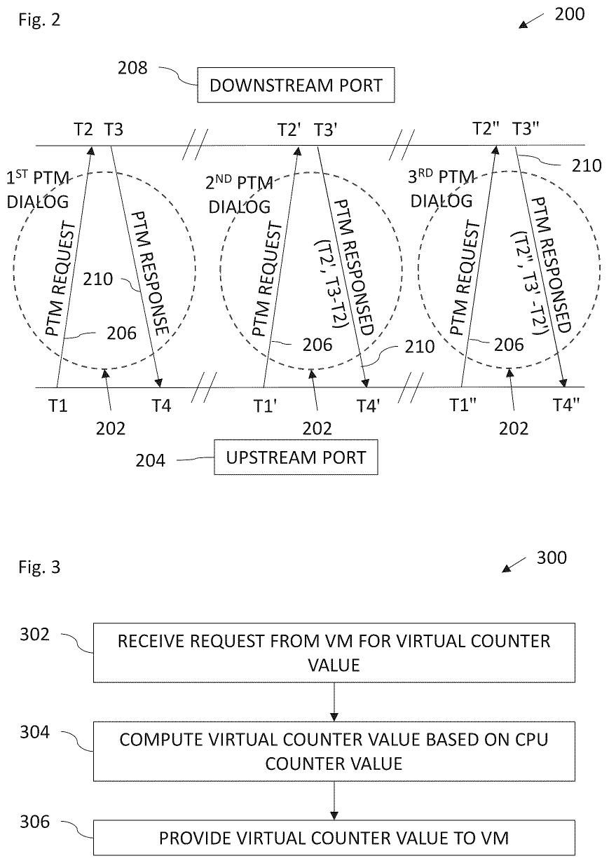

For example, the timing data may include the peripheral device time when the PTM request was sent (T1′), PTM master time when the PTM request was received (T2′) transformed to the frame of reference of the VM (by the responder device) and the one-way delay across the PCIe interface measured by the peripheral device [(T4−T1)−(T3−T2)]/2 using nomenclature from PTM link protocol diagrams, described in more detail with reference to FIG. 2.

For example, the timing data may include the peripheral device time when the latest PTM request was sent (T1′), the PTM master time when the latest PTM request was received (T2′) transformed to the frame of reference of the VM (by the responder device) and data necessary to calculate the one-way delay (i.e., the differences T4 minus T1 and T3 minus T2 using nomenclature from PTM link protocol diagrams, described in more detail with reference to FIG. 2).

For example, the timing data may include the peripheral device time when the latest PTM request was sent (T1′), PTM master time when latest PTM request was received (T2′) and data necessary to calculate the one-way delay (i.e., the T1, T2, T3 and T4 timestamps). Translation would be applied to T2′, T2 and T3 by the responder device.

### System Description

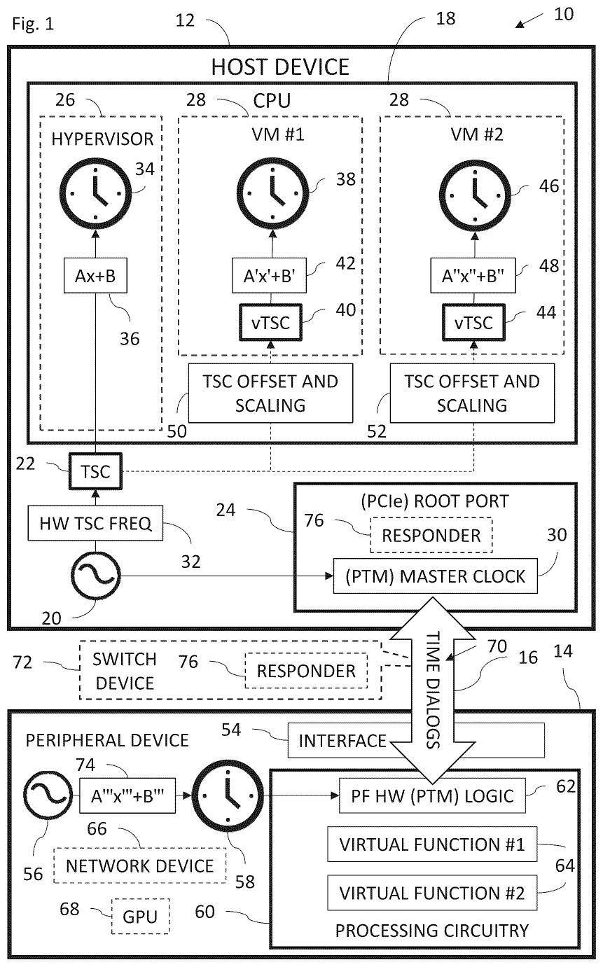

Reference is now made to FIG. 1, which is a block diagram view a clock measurement system 10 constructed and operative in accordance with an embodiment of the present disclosure. The clock measurement system 10 includes a host device 12 and a peripheral device 14 connected via a data communication bus 16.

The host device 12 includes a central processing unit (CPU) 18, an oscillator 20, a CPU counter 22 (e.g., a TSC), and a root port 24. The CPU 18 is configured to execute (i.e., run) a hypervisor 26, and one or more virtual machines (VMs) 28 managed by the hypervisor 26. In the example of FIG. 1, the VMs 28 include two VMs, VM #1 and VM #2.

The host device 12 also includes a master clock 30 (e.g., a PTM master clock) to maintain a master clock time (e.g., a PTM master clock time). The master clock 30 may be comprised in the root port 24 (e.g., a PCIe root port).

The oscillator 20 is configured to provide an output signal for use by the master clock 30 and the CPU counter 22. In some embodiments, the master clock 30 and the CPU counter 22 may derive from different frequency sources. The master clock 30 and the CPU counter 22 may operate at different frequencies. For example, a hardware TSC frequency 32 feeds the CPU counter 22 and the hardware TSC frequency 32 may be a multiple, or a fraction, or the same, as the frequency of the oscillator 20. The value of the CPU counter 22 has a given relationship with the master clock time maintained by the master clock 30. The hypervisor 26 may maintain a clock 34 (e.g., with a time-of-day clock value) which is based on applying a transformation Ax+B (block 36) where x is the counter value of the CPU counter 22 and A and B are parameters. VM #1 may have a virtual time counter 40 (e.g., vTSC) based on an offset and scaling (block 50) from the CPU counter 22. VM #1 may maintain a clock 38 (e.g., with a time-of-day clock value) which is based on applying a transformation A′x′+B′ (block 42) where x′ is the counter value of the virtual time counter 40 and A′ and B′ are parameters. VM #2 may have a virtual time counter 44 (e.g., vTSC) based on an offset and scaling (block 52) from the CPU counter 22. VM #2 may maintain a clock 46 (e.g., with a time-of-day clock value) which is based on applying a transformation A″x″+B″ (block 48) where x″ is the counter value of the virtual time counter 44 and A″ and B″ are parameters.

The peripheral device 14 includes an interface 54, an oscillator 56, a hardware clock 58, and processing circuitry 60. The interface 54 is configured to transfer data between the root port 24 of the host device 12 via data communication bus 16. The hardware clock 58 is configured to maintain a peripheral device clock time. The oscillator 56 is configured to provide a clock signal to hardware clock 58. The hardware clock 58 may also include a counter (not shown) maintaining a counter value to which a transformation A″x″+B″ (block 74) is applied to yield the peripheral device clock time.

The processing circuitry 60 may execute a physical function (PF) 62 to perform hardware logic, e.g., hardware PTM logic. The processing circuitry 60 may also execute virtual functions (VFs) 64 corresponding to the VMs 28. For example, the virtual functions 64 may include virtual function #1 for VM #1, and virtual function #2 for VM #2. In some embodiments, the hypervisor 26 instantiates (i.e., requests that the processing circuitry 60 of the peripheral device 14 creates) the VFs in the peripheral device 14.

The peripheral device 14 may optionally include a network device 66 (e.g., a network interface controller (NIC) application-specific integrated circuit (ASIC). In some embodiments, one or more of the virtual functions 64 may be virtual network adapter(s) of the VM(s). The peripheral device 14 may optionally include a graphics processing unit (GPU) 68. In some embodiments, one or more of the virtual functions 64 may be a virtual GPU(s) of the VM(s).

In some embodiments, the clock measurement system 10 may include one or more (data communication bus) switch devices 72 (e.g., PCIe switch devices) disposed in the data communication bus 16 between the host device 12 and the peripheral device 14. When there is one switch device 72 in the data communication bus 16, the peripheral device 14 exchanges time measurement messages with the (PCIe) switch 72 (not with the host device 12) and the (PCIe) switch 72 responds with Master Time information based on the measurement dialogs it exchanged with the host device 12. If there is more than one switch device 72, the PTM messages are exchanged between the direct link partners, i.e., the PTM messages are not forwarded across the (PCIe) switches 72.

The clock measurement system 10 includes a responder device 76. The responder device 76 is associated with the data communication bus 16 disposed between the host device 12 and the peripheral device 14. The root port 24 may be included in the responder device 76. In some embodiments, the switch device 72 connected to peripheral device 14 includes responder device 76.

The processing circuitry 60 is configured to share time measurement messages with the host device 12 yielding time measurement dialogues 70 according to any suitable time measurement standard. In some embodiments, the VFs may share time measurement messages with the responder device 76 (e.g., root port 24 or with the switch 72 connected to the peripheral device 14).

In practice, some, or all of the functions of the processing circuitry 60 may be combined in a single physical component or, alternatively, implemented using multiple physical components. These physical components may comprise hard-wired or programmable devices, or a combination of the two. In some embodiments, at least some of the functions of the processing circuitry 60 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Reference is now made to FIG. 2, which is a data flow diagram 200 showing example time measurement dialogues 202 in the system 10 of FIG. 1. FIG. 2 shows three time-measurement dialogues 202 as labeled in FIG. 2. Each time measurement dialogue 202 includes an upstream port 204 (e.g., peripheral device 14) sending a PTM request 206 to a downstream port 208 (e.g., root port 24 of host device 12 or switch device 72), and the downstream port 208 sending a PTM Response 210 (or ResponseD) to the upstream port 204. The various times, T1, T2, T3, T4, T1′ etc. shown in FIG. 2 provide the various transmit and receive times of the messages included in the time measurement dialogues 202.

The PTM master time at time T1′ may be equal to:

$$T {2}^{′} - \frac{( ( T 4 - T 1 ) - ( T 3 - T 2 ) )}{2}$$

Reference is now made to FIG. 3, which is a flowchart 300 including steps in a method performed by CPU 18 of host device 12 in the system 10 of FIG. 1. The CPU 18 is configured to receive a request from one of the VMs 28 (e.g., VM #1) for a virtual counter value of the virtual time counter 40 of VM #1 (block 302). The request may be inferred by the CPU 18 from an action performed by VM #1 such as VM #1 trying to read a memory address associated with the virtual time counter 40. The CPU 18 is configured to compute the virtual counter value of the virtual time counter 40 based on a given relationship (e.g., A′x′+B′) between the value of the CPU counter 22 and the virtual counter value (block 304). The CPU 18 is configured to provide the virtual counter value of VM #1 to VM #1 (block 306) upon request of VM #1 and based on the given relationship between the value of the CPU counter and the virtual counter value of VM #1.

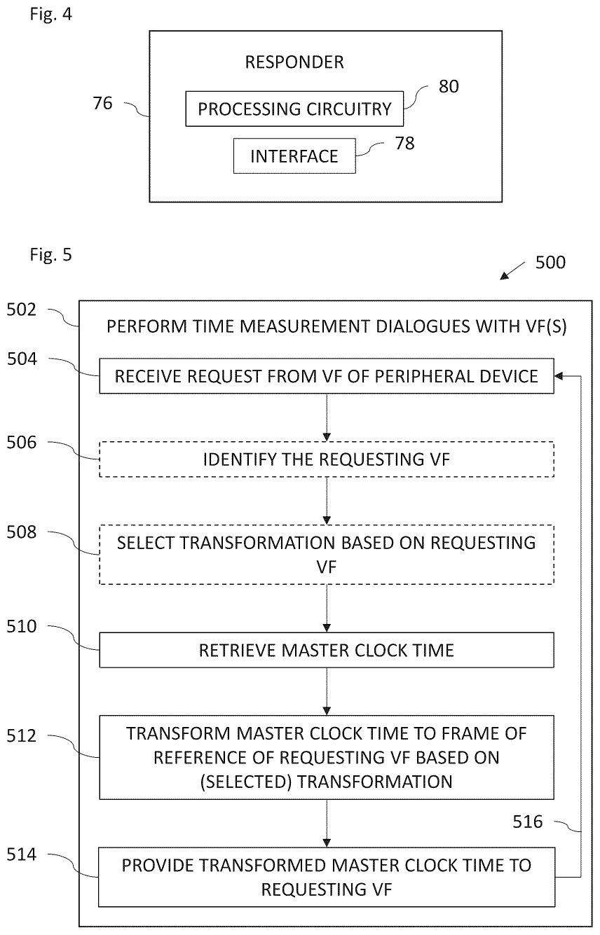

Reference is now made to FIG. 4, which is a block diagram view of responder device 76 of the system 10 of FIG. 1. The responder device 76 may include an interface 78 to share data with the peripheral device 14. The responder device 76 may also include processing circuitry 80, described in more detail with reference to FIG. 5. In practice, some, or all of the functions of the processing circuitry 80 may be combined in a single physical component or, alternatively, implemented using multiple physical components. These physical components may comprise hard-wired or programmable devices, or a combination of the two. In some embodiments, at least some of the functions of the processing circuitry 80 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Reference is now made to FIG. 5, which is a flowchart 500 including steps in a method performed by the responder device 76 of FIG. 4. The processing circuitry 80 is configured to perform a time measurement dialogue with a given one of the virtual functions (VFs) 64 (block 502). The time measurement dialogue includes measurement messages exchanged by the responder device 76 and the given VF 64 (e.g., VF #2) of peripheral device 14, with the measurement messages including translated values of the master clock time in the frame of reference of the VM (e.g., VM #2), as described in more detail below.

The steps of blocks 504-514 describe the processing steps of responder device 76 receiving a request from one of the virtual functions 64 and responding to the request. In the example below, a given VF 64 (e.g., VF #2) is discussed. However, the steps may be performed for any of the VFs 64.

The processing circuitry 80 of responder device 76 is configured to receive a request from the given VF 64 (e.g., VF #2) of peripheral device 14 via interface 78 and data communication bus 16 (block 504). The request may include data that includes a VF-specific requester identification (ID), which identifies the VF (e.g., VF #2) providing the request to responder device 76. Therefore, in some embodiments, the VFs 64 are configured to generate requests with the VF-specific requester IDs, in order for the responder device 76 to identify which of the VFs is making a given request.

In some embodiments, the processing circuitry 80 is configured to identify the “requesting” VF 64 (e.g., VF #2) making the request, e.g., based on the VF-specific requester ID included in the received request (block 506). Identifying the requesting VF (e.g., VF #2) allows the responder device 76 to use the correct transformation to translate the master clock time to the frame of reference of the VM 28 (e.g., VM #2), which corresponds to the requesting VF (e.g., VF #2), as described in more detail below.

In some embodiments, the processing circuitry 80 is configured to select from a plurality of transformations between the master clock time and respective virtual counter values of the plurality of VMs to find the correct transformation to be used to translate the master clock time for the requesting VF 64 (e.g., VF #2) and the corresponding VM 28 (e.g., VM #2) (block 508). For example, the processing circuitry 80 may select from: (i) transformation A to translate a master clock time value to the frame of reference of VM #1 in response to a request from VF #1; and (ii) transformation B to translate a master clock time value to the frame of reference of VM #2 in response to a request from VF #2, and so on.

The processing circuitry 80 is configured to retrieve or receive a value of the master clock time, e.g., from master clock 30 (FIG. 1) (block 510). The processing circuitry 80 is configured to transform the retrieved/received value of the master clock time to a frame of reference of the VM 28 (e.g., VM #2) associated with (corresponding to) the requesting VF 64 (e.g., VF #2) based on the (selected) transformation (found in the step of block 508) between the master clock time and the virtual counter value of that VM 28 (e.g., VM #2) (block 512). The transformation between the master clock time and the virtual counter value of the VM 28 (e.g., VM #2) is based on (a) the given relationship between the value of the CPU counter 22 and the master clock time; and (b) the given relationship between the value of the CPU counter 22 and the virtual counter value of the VM 28 (e.g., VM #2). The transformation may include a constant addition/subtraction factor and a constant multiplication/division factor. The processing circuitry 80 is configured to provide the transformed master clock time, e.g., in a message, to the “requesting” VF 64 (e.g., VF #2) (block 514).

As part of a setup step, the hypervisor 26 is configured to configure the responder device 76 to apply the transformations to retrieved/received values of the master clock time according to the VFs requesting time responses. For example, apply transformation A to requests from VF #1, and transformation B to requests from VF #2, and so on.

The steps of blocks 504-514 may be repeated for requests from the same VF and/or from different VFs (arrow 516). Therefore, the processing circuitry 80 may be configured to perform respective time measurement dialogues with different ones of the VFs 64 including measurement messages exchanged by the responder device 76 and the VFs 64 of peripheral device 14. The measurement messages include translated values of the master clock time in the respective frames of reference of the respective VMs 28 corresponding with the requesting VFs 64. The processing circuitry 80 is configured to select from the plurality of transformations between the master clock time and the respective virtual counter values of the VMs 28 based on data (e.g., VF-specific requester identifications (IDs)) included in requests received from the VFs 64. The processing circuitry 80 is configured to transform values of the master clock time to respective frames of reference of respective VMs 28 based on respective transformations. For example, the processing circuitry 80 applies transformation A to translate master clock time values to the frame of reference of VM #1 in response to requests from VF #1, and transformation B to translate master clock time values to the frame of reference of VM #2 in response to requests from VF #2, and so on.

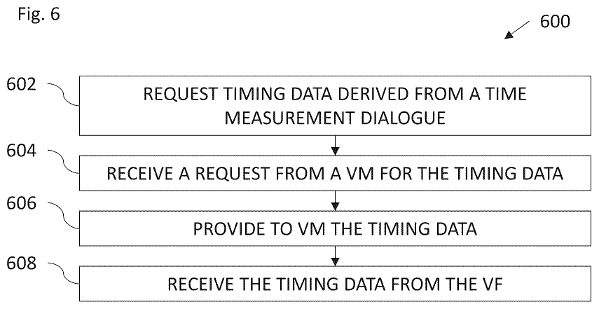

Reference is now made to FIG. 6, which is a flowchart 600 including steps in a method performed by one of the virtual machines 28 and a corresponding one of the virtual functions 64 in the system 10 of FIG. 1. One of the VMs 28 (e.g., VM #1) is configured to request, from the VF 64 (e.g., VF #1 associated with the requesting VM) over data communication bus 16 timing data derived from a time measurement dialogue (between that VF 64 and the responder device 76) (block 602). The interface 54 is configured to receive from the requesting VM 28 (e.g., VM #1) running on host device 12, over data communication bus 16, the request for the timing data derived from the time measurement dialogue (between that VF 64 (e.g., VF #1) and the responder device 76) (block 604). The (VF 64 (e.g., VF #1) of the requesting VM (e.g., VM #1) running on the) processing circuitry 60 is configured to provide to the requesting VM, over the data communication bus 16, the timing data (block 606). The timing may include any suitable timing data as described in more detail above in the overview section. The VM 28 (e.g., VM #1) is configured to receive the timing data from that VF 64 (e.g., VF #1) over data communication bus 16 (block 608).

A simplified numerical example for the PTM master time translation in the peripheral device 14 now follows.

The following are definitions of terminology used in the example:
(a) PTM.MT is PTM master time as maintained in the PCIe Root Port and used in PCIe PTM dialogs. PTM.MT may be equal to the number of nanoseconds that have passed since boot of host device 12 when the value of PTM.MT counter is incremented once every nanosecond.
(b) vPTM.MT is the PTM master time translated to the VM's frame of reference according to this disclosure.
(c) DEVCNT is the peripheral device hardware (HW) counter and may be equal to the number of device cycles since device boot or number of nanoseconds since device boot or number of nanoseconds since Jan. 1, 1970, or some other format-but the actual format is irrelevant for this disclosure.
(d) TSC is the TimeStamp Counter or CPU HW counter and may be equal to the number of CPU cycles since boot.
(e) vTSC is the virtualized TSC made available to the Virtual Machine.

The example below provides arbitrary values for various coefficients and/or frequencies and other values.

Assuming TSC runs at 4 GHz (i.e., every nanosecond, the value of TSC is increased by 4, or, conversely, the value of TSC is incremented 4 times per nanosecond), it follows that:

$$TSC\_RATE = 4 , and$$

$$TSC = PTM . MT * TSC\_RATE = PTM . MT * 4$$

PTM.MT is expressed in nanoseconds and both TSC and PTM.MT start at 0 on CPU boot.

On the other hand, assuming vTSC runs at 2 GHz (i.e., if the Virtual Machine were to read the vTSC value in two successive nanoseconds, it would read a value of X and a value of X+2, respectively, or conversely speaking, the value of vTSC is incremented 2 times per nanosecond) and this is what the CPU provides to the VM, i.e., the CPU informs the VM that the vTSC frequency is 2 GHz, i.e., vTSC_RATE=2.

Additionally, assuming vTSC is then additionally offset by a constant value, e.g., 10000., vTSC_OFFSET=10000.

From this it follows that vTSC=(vTSC_RATE/TSC_RATE)*TSC+vTSC_OFFSET,
which is
=(2/4)*TSC+10000=0.5*TSC+10000, in our example.

For illustration purposes a bare-metal example is now provided.

If an application running on the bare metal (not in the Virtual Machine) would use PTM, it would obtain two values from the peripheral device (a simultaneous snapshot of PTM.MT and DEVCNT), namely, PTM.MT_0=500, and DEVCNT_0=450.

The bare metal would then calculate the corresponding TSC value and use it together with the device counter e.g., for purposes of synchronization, giving:

$$TSC\_ 0 = 4 * PTM . MT\_ 0 = 4 * 500 = 2000 , and$$

$$DEVCNT\_ 0 = 450.$$

Now, the same scenario is executed for the VM. The PTM dialogs still produce two values: PTM.MT_0=500, and DEVCNT_0=450.

The corresponding “HW”/bare-metal TSC value is still:

$$TSC\_ 0 = 4 * PTM . MT\_ 0 = 4 * 500 = 2000 .$$

The corresponding virtualized vTSC value is however:

$$vTSC\_ 0 = 0 \text{.5} * TSC\_ 0 + 10000 = 0.5 * 2000 + 10 \; 000 = 1000 + 10000 = 11000 .$$

The virtual machine “thinks” that the vTSC runs at 2 GHz and so when it gets the virtualized PTM master time value from the peripheral device, it will calculate vTSC as:

$$vTSC\_ 0 = 2 * vPTM . MT\_ 0$$

Therefore, the responder device 76 must produce a virtualized PTM master time value such that when the Virtual Machine calculates the corresponding vTSC value, the VM will obtain the correct value.

The vPTM.MT_0 value that should be provided is therefore 5500.

That value (i.e., 5500) maybe produced based on:

$$vPTM . MT = P T M . M T + vTSC\_OFFSET / vTSC\_RATE \qquad ( equation 1 )$$

Therefore, vPTM.MT=PTM.MT+vTSC_OFFSET/vTSC_RATE=PTM.MT+10000/2=PTM.MT+5000.

Therefore, the value that should be provided is:

$$vPTM . MT\_ 0 = P T M . MT\_ 0 + 5000 = 500 + 5000 = 5500$$

Equation may be obtained by solving the following equations:

On one hand

$$vTSC = vTSC\_RATE * vPTM . MT , \qquad ( equation 2 )$$

and on the other hand

$$vTSC = TSC\_SCALING * TSC + TSC\_OFFSET , \qquad ( equation 3 )$$

$$Where TSC\_SCALING = vTSC\_RATE / TSC\_RATE , \qquad ( equation 4 )$$

$$and$$

$$TSC = TSC\_RATE * PTM . MT .$$

Therefore, taking right sides of equations 2 and 3 gives:

$$vTSC\_RATE * vPTM . MT = TSC\_SCALING * TSC + TSC\_OFFSET$$

Substituting TSC_SCALING from equation 4 gives:

$$vTSC\_RATE * vPTM . MT = ( vTSC\_RATE / TSC\_RATE ) * TSC + TSC\_OFFSET$$

Substituting TSC gives:

$$vTSC\_RATE * vPTM . MT = ( vTSC\_RATE / TSC\_RATE ) * TSC\_RATE * PTM . MT + TSC\_OFFSET$$

Simplify the right-hand side of the equation (TSC_RATE cancels out) giving:

$$vTSC\_RATE * vPTM . MT = vTSC\_RATE * PTM . MT + TSC\_OFFSET .$$

Dividing both sides of the equation by vTSC_RATE provides vPTM.MT as a function of PTM.MT as follows:

$$vPTM . MT = P T M . M T + TSC\_OFFSET / vTSC\_RATE . \qquad ( equation 1 )$$

The peripheral device 14 may be any suitable device, such as: an accelerator device; a processing device including a central processing unit (CPU) and/or a graphics processing unit (GPU); a network device, e.g., a network interface controller (NIC) device, a data processing unit (DPU) or smart NIC including a NIC and one or more processing cores, or a network switch. One or more of the processing steps described hereinabove may be performed by a CPU, GPU, DPU, NIC, or any suitable combination thereof.

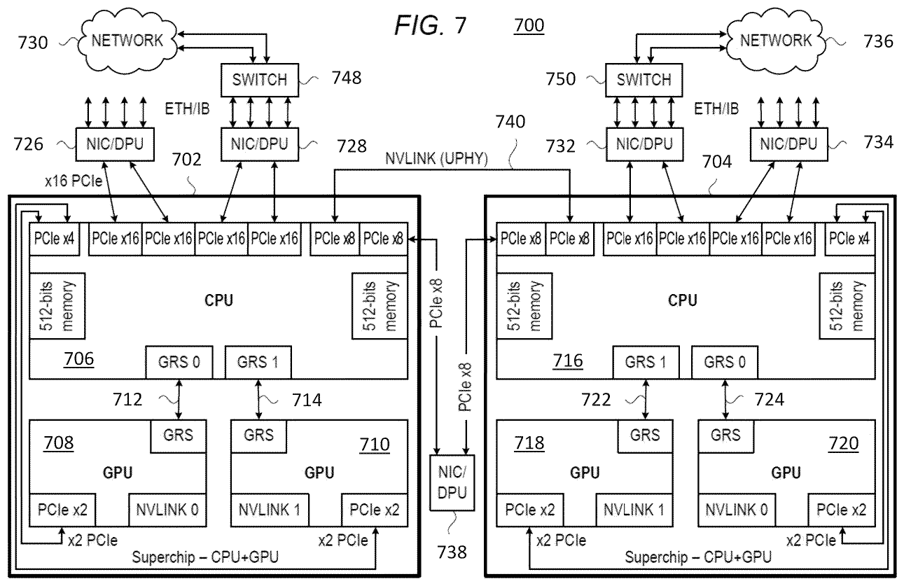

The device(s) 12, 14 may be disposed in any suitable environment, such as a data center as described in more detail below with reference to FIG. 7. The data center may include cooling systems, power supply, network components such as NICs and switches and cabling to provide high-speed connectivity e.g., with multiple internet providers for redundancy, physical and cyber protections, including access controls and surveillance, organized spaces for servers and equipment. The data center may support remote storage and computing for cloud services.

Reference is now made to FIG. 7, which demonstrates an example architecture of a multi-GPU architecture. As illustrated in the figure, computing system 700 includes a processing device 702 with a multi-GPU architecture. In particular, processing device 702 may be a system-on-chip and includes multiple subsystems such as a CPU 706, a GPU 708, and a GPU 710. CPU 706 can be coupled to GPU 708 via a die-to-die (D2D) or chip-to-chip (C2C) interconnect 712, such as a Ground-Referenced Signaling interconnect (GRS interconnect). CPU 706 can be coupled to GPU 710 via a D2D or C2C interconnect 714. CPU 706 can also couple to GPU 708 and GPU 710 via PCIe interconnects.

CPU 706 can be coupled to one or more NICs or DPUs, which are coupled to one or more networks. For example, as illustrated in FIG. 7, CPU 706 is coupled to a first NIC/DPU 726, which is coupled to a network 730. CPU 706 is also coupled to a second NIC/DPU 728, which is coupled to network 730 via switch 748. NIC/DPU 726 and NIC/DPU 728 can be coupled to network 730 over Ethernet (ETH), NVLINK or InfiniBand (IB) connections, for example.

Computing system 700 also includes a processing device 704 with a multi-GPU architecture. In particular, processing device 704 includes multiple subsystems including a CPU 716, a GPU 718, and a GPU 720. CPU 716 can be coupled to GPU 718 via a D2D or C2C interconnect 722. CPU 716 can be coupled to GPU 720 via a D2D or C2C interconnect 724. CPU 716 can also couple to GPU 718 and GPU 720 via PCIe interconnects. CPU 716 can be coupled to one or more NICs or DPUs, which are coupled to one or more networks. For example, as illustrated in FIG. 7, CPU 716 is coupled to a first NIC/DPU 732, which is coupled to a network 736. CPU 716 is also coupled to a second NIC/DPU 734, which is coupled to network 736 via switch 750. NIC/DPU 732 and NIC/DPU 734 can be coupled to network 736 over Ethernet (ETH), NVLINK or InfiniBand (IB) connections.

In at least one embodiment, processing device 702 and processing device 704 can communicate with each other via a NIC/DPU 738, such as over PCIe interconnects. Processing device 702 and processing device 704 can also communicate with each other over a high-bandwidth communication interconnect 740, such as an NVLink interconnect or other high-speed interconnects. The packet switches in FIG. 7 may comprise, for example, Nvidia Quantum-2 switches. The NICs/DPUs in the figure may comprise, for example, Nvidia Bluefield DPUs.

The NIC may include any of the following: an Ethernet Port (RJ45 Connector), which is the physical interface where the network cable (usually an Ethernet cable) connects to the NIC and is used for wired network connections; packet processing hardware or circuitry, which is responsible for handling network communication and processes incoming and outgoing data packets and manages the network interface functions; a memory (such as RAM or ROM) to store temporary data, such as network packet buffers, configuration settings, and firmware, and helps in speeding up data transfer and processing; firmware, which is software programmed into the NIC's memory and controls the hardware operations and may perform firmware updates to improve performance or add new features to the NIC; LED Indicators that provide visual indicators of network status, common indicators including power status, network activity, and link speed; a bus Interface (e.g., PCI or PCIe) to connect the NIC to the host computer's motherboard; a processor to handle network processing tasks as well as other processing tasks to offload work from the main CPU of the host device and improve network performance; a heat sink or cooling mechanism (e.g., for high-performance NICs), especially those used in servers, to prevent overheating; power management circuitry to ensure the NIC receives the correct amount of power and manages power consumption efficiently; and/or connector pins and circuitry including internal connections and pathways that route signals between the NIC's components.

The packet processing hardware or circuitry is the central component of the NIC and handles network communications. It may include several key components that work together to manage and process network data, such as any one or more of the following: MAC (Media Access Control) Layer, which is responsible for handling the data link layer of the OSI model and manages how data packets are formatted, addressed, and transmitted over the network; MAC address register, which stores the unique hardware address (MAC address) of the NIC; a frame buffer that temporarily holds data frames as they are being processed; a PHY (Physical Layer) Interface that interfaces with the physical medium (such as Ethernet cables) and is responsible for the actual transmission and reception of data bits over the network; a transceiver that converts data between the digital signals used by the MAC layer and the analog signals used for transmission over the network medium; DMA (Direct Memory Access) Controller that manages data transfers between the NIC and the computer's memory without involving the CPU and helps to offload processing tasks from the CPU and improve data transfer efficiency; a packet Processing Engine that handles the encapsulation and decapsulation of network packets, and processes incoming and outgoing packets, managing tasks like error checking and packet filtering; buffer management, which includes memory areas for storing packets temporarily, such as transmit buffers to store packets that are being sent from the computer to the network, receive buffers to store packets received from the network before they are processed by the system; an interrupt controller that manages and generates interrupts to notify the CPU of events such as packet reception or transmission completion and helps in efficient handling of network events; a clock generator, which provides timing signals for the various components of the NIC to synchronize their operations; a power management unit to regulate power consumption and manages power-saving features of the NIC chip to improve energy efficiency; error handling and correction logic, which detects and corrects errors in data transmission and reception, and may include features for error-checking protocols like CRC (Cyclic Redundancy Check); configuration registers that store configuration settings and parameters that control the NIC's operation, such as speed settings, interrupt configurations, and buffer sizes; firmware/ROM that contains the embedded software that controls the NIC's operations and manages network protocols.

The network switch may include any of the following: ports where network cables connect; switching fabric that manages data transfer between ports; a MAC address table that stores device addresses and port information; a forwarding engine that directs data packets to the correct ports; buffer memory that temporarily holds data to manage traffic; a management processor that handles configuration and monitoring in managed switches; a power supply that provides electrical power; a cooling system that keeps the switch from overheating; firmware that controls the switch; LED Indicators that show status and activity; and networking modules (in modular switches) that allow for additional ports or features.

Regarding the graphics processing unit, graphics processing units (GPUs) are employed to generate three-dimensional (3D) graphics objects and two-dimensional (2D) graphics objects for a variety of applications, including feature films, computer games, virtual reality (VR) and augmented reality (AR) experiences, mechanical design, and/or the like. A modern GPU includes texture processing hardware to generate the surface appearance, referred to herein as the “surface texture,” for 3D objects in a 3D graphics scene. The texture processing hardware applies the surface appearance to a 3D object by “wrapping” the appropriate surface texture around the 3D object. This process of generating and applying surface textures to 3D objects results in a highly realistic appearance for those 3D objects in the 3D graphics scene.

The texture processing hardware is configured to perform a variety of texture-related instructions, including texture operations and texture loads. The texture processing hardware generates accesses texture information by generating memory references, referred to herein as “queries,” to a texture memory. The texture processing hardware retrieves surface texture information from the texture memory under varying circumstances, such as while rendering object surfaces in a 3D graphics scene for display on a display device, while rendering 2D graphics scene, or during compute operations.

Surface texture information includes texture elements (referred to herein as “texels”) used to texture or shade object surfaces in a 3D graphics scene. The texture processing hardware and associated texture cache are optimized for efficient, high throughput read-only access to support the high demand for texture information during graphics rendering, with little or no support for write operations. Further, the texture processing hardware includes specialized functional units to perform various texture operations, such as level of detail (LOD) computation, texture sampling, and texture filtering.

In general, a texture operation involves querying multiple texels around a particular point of interest in 3D space, and then performing various filtering and interpolation operations to determine a final color at the point of interest. By contrast, a texture load typically queries a single texel, and returns that directly to the user application for further processing. Because filtering and interpolating operations typically involve querying four or more texels per processing thread, the texture processing hardware is conventionally built to accommodate generating multiple queries per thread. For example, the texture processing hardware could be built to accommodate up to four texture memory queries performed in a single memory cycle. In that manner, the texture processing hardware is able to query and receive most or all of the needed texture information in one memory cycle.

In practice, some or all of these functions may be combined in a single physical component or, alternatively, implemented using multiple physical components. These physical components may comprise hard-wired or programmable devices, or a combination of the two. In some embodiments, at least some of the functions of the processing circuitry may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

The implementation of the method and/or system of examples of the disclosure can involve performing or completing selected tasks manually, automatically, or a combination thereof. Moreover, according to actual instrumentation and equipment of examples of the method and/or system of the disclosure, several selected tasks could be implemented by hardware, by software or by firmware or by a combination thereof using an operating system or a cloud-based platform.

For example, hardware for performing selected tasks according to examples of the disclosure could be implemented as a chip or a circuit. As software, selected tasks according to examples of the disclosure could be implemented as a plurality of software instructions being executed by a computer using any suitable operating system. In an exemplary example of the disclosure, one or more tasks according to exemplary examples of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed examples of the present disclosure. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various examples of computer-implemented methods are provided herein, some of which can be performed by various examples of apparatuses and systems described herein and some of which can be performed according to instructions stored in non-transitory computer-readable storage media described herein. Still, some examples of computer-implemented methods provided herein can be performed by other apparatuses or systems and can be performed according to instructions stored in computer-readable storage media other than that described herein, as will become apparent to those having skill in the art with reference to the examples described herein. Any reference to systems and computer-readable storage media with respect to the following computer-implemented methods is provided for explanatory purposes, and is not intended to limit any of such systems and any of such non-transitory computer-readable storage media with regard to examples of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the figures illustrate the architecture, functionality, and operation of possible implementations of systems, methods and computer program products according to various examples of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The descriptions of the various examples of the present disclosure have been presented for purposes of illustration, but are not intended to be exhaustive or limited to the examples disclosed. Many modifications and variations will be apparent to those of ordinary skill in the art without departing from the scope and spirit of the described examples.

As used herein, the singular form “a”, “an” and “the” include plural references unless the context clearly dictates otherwise.

It is appreciated that certain features of the disclosure, which are, for clarity, described in the context of separate examples, may also be provided in combination in a single example. Conversely, various features of the disclosure, which are, for brevity, described in the context of a single example, may also be provided separately or in any suitable sub-combination or as suitable in any other described example of the disclosure. Certain features described in the context of various examples are not to be considered essential features of those examples unless the example is inoperative without those elements.

The above-described processes including portions thereof can be performed by software, hardware and combinations thereof. These processes and portions thereof can be performed by computers, computer-type devices, workstations, cloud-based platforms, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these examples to practice without undue experimentation. The processes (methods) and systems have been described in a manner sufficient to enable persons of ordinary skill in the art to readily adapt other hardware and software as may be needed to reduce any of the examples to practice without undue experimentation and using conventional techniques.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A responder device associated with a data communication bus between a host device and a peripheral device, the host device being to execute a virtual machine (VM) and maintain a master clock time, the peripheral device being to execute a virtual function (VF) associated with the VM, the responder device including:
an interface to share data with the peripheral device; and
processing circuitry to:
transform values of the master clock time to a frame of reference of the VM based on a transformation between the master clock time and a virtual counter value of the VM; and
perform a time measurement dialogue with the VF including measurement messages exchanged by the responder device and the peripheral device, the measurement messages including translated values of the master clock time in the frame of reference of the VM.

2. The device according to claim 1, wherein the host device includes a root port, which includes: the responder device; and a master clock to maintain the master clock time.

3. The device according to claim 2, wherein the host device includes:
a CPU counter, wherein a value of the CPU counter has a given relationship with the master clock time; and
a central processing unit (CPU) to:
run a hypervisor to manage the VM;
provide the virtual counter value of the VM to the VM upon request of the VM based on a given relationship between the value of the CPU counter and the virtual counter value of the VM, wherein the transformation between the master clock time and the virtual counter value of the VM is based on (a) the given relationship between the value of the CPU counter and the master clock time; and (b) the given relationship between the value of the CPU counter and the virtual counter value; and
instantiate the VF in the peripheral device.

4. The device according to claim 1, wherein the data communication bus includes a switch device including the responder device.

5. The device according to claim 1, wherein the host device includes:
a root port, which includes a master clock to maintain the master clock time;
a CPU counter, wherein a value of the CPU counter has a given relationship with the master clock time; and
a central processing unit (CPU) to:
run a hypervisor to manage the VM;
provide the virtual counter value of the VM to the VM upon request of the VM based on a given relationship between the value of the CPU counter and the virtual counter value of the VM, wherein the transformation between the master clock time and the virtual counter value of the VM is based on (a) the given relationship between the value of the CPU counter and the master clock time; and (b) the given relationship between the value of the CPU counter and the virtual counter value; and
instantiate the VF in the peripheral device.

6. The device according to claim 5, wherein:
the VM is to request, from the VF over the data communication bus, timing data derived from the time measurement dialogue; and
the VM is to receive the timing data from the VF over the data communication bus.

7. The device according to claim 6, wherein the VF is to provide the timing data to the VM over the data communication bus.

8. The device according to claim 7, wherein:
the peripheral device includes a network device; and
the VF is a virtual network adapter of the VM.

9. The device according to claim 1, wherein:
the host device is to execute a plurality of VMS;
the peripheral device is to execute a plurality of VFs corresponding to the plurality of VMs;
the processing circuitry is to:
select from a plurality of transformations between the master clock time and respective virtual counter values of the plurality of VMs;
transform values of the master clock time to respective frames of reference of respective ones of the plurality of VMs based on respective ones of the transformations; and
perform time measurement dialogues with the plurality of VFs including measurement messages exchanged by the responder device and the peripheral device, the measurement messages including translated values of the master clock time in the respective frames of reference.

10. The device according to claim 9, wherein the processing circuitry is to select from the plurality of transformations between the master clock time and the respective virtual counter values of the plurality of VMs based on data included in requests received from the VFs.

11. The device according to claim 9, wherein the data included in the requests includes VF-specific requester identifications (IDs).

12. The device according to claim 11, wherein the VFs are to generate the requests with the VF-specific requester IDs.

13. The device according to claim 9, wherein the host device includes a central processing unit (CPU) to run a hypervisor to manage the VM, the hypervisor being to configure the responder device to apply the transformations to given values of the master clock time according to the VFs requesting time responses.

14. The device according to claim 1, wherein the transformation includes a constant addition/subtraction factor and a constant multiplication/division factor.

15. A system, comprising:
a host device to execute a virtual machine (VM) and maintain a master clock time;
a data communication bus disposed between the host device and the peripheral device;
a peripheral device to execute a virtual function (VF) associated with the VM; and
a responder device, comprising: an interface to share data with the peripheral device; and processing circuitry to:
transform values of the master clock time to a frame of reference of the VM based on a transformation between the master clock time and a virtual counter value of the VM; and
perform a time measurement dialogue with the VF including measurement messages exchanged by the responder device and the peripheral device, the measurement messages including translated values of the master clock time in the frame of reference of the VM.

16. The system according to claim 15, wherein the host device includes a root port, which includes:
the responder device; and
a master clock to maintain the master clock time.

17. The system according to claim 16, wherein the host device includes:
a CPU counter, wherein a value of the CPU counter has a given relationship with the master clock time; and
a central processing unit (CPU) to:
run a hypervisor to manage the VM;
provide the virtual counter value of the VM to the VM upon request of the VM based on a given relationship between the value of the CPU counter and the virtual counter value of the VM, wherein the transformation between the master clock time and the virtual counter value of the VM is based on (a) the given relationship between the value of the CPU counter and the master clock time; and (b) the given relationship between the value of the CPU counter and the virtual counter value; and
instantiate the VF in the peripheral device.

18. The system according to claim 15, further comprising a data communication bus switch device including the responder device.

19. The system according to claim 15, wherein the host device includes:
a root port, which includes a master clock to maintain the master clock time;
a CPU counter, wherein a value of the CPU counter has a given relationship with the master clock time; and
a central processing unit (CPU) to:
run a hypervisor to manage the VM;
provide the virtual counter value of the VM to the VM upon request of the VM based on a given relationship between the value of the CPU counter and the virtual counter value of the VM, wherein the transformation between the master clock time and the virtual counter value of the VM is based on (a) the given relationship between the value of the CPU counter and the master clock time; and (b) the given relationship between the value of the CPU counter and the virtual counter value; and
instantiate the VF in the peripheral device.

20. The system according to claim 19, wherein:
the VM is to request, from the VF over the data communication bus, timing data derived from the time measurement dialogue; and
the VM is to receive the timing data from the VF over the data communication bus.

21. The system according to claim 20, wherein the VF is to provide the timing data to the VM over the data communication bus.

22. The system according to claim 21, wherein:
the peripheral device includes a network device; and
the VF is a virtual network adapter of the VM.

23. The system according to claim 15, wherein:
the host device is to execute a plurality of VMs;
the peripheral device is to execute a plurality of VFs corresponding to the plurality of VMs;
the processing circuitry is to:
select from a plurality of transformations between the master clock time and respective virtual counter values of the plurality of VMs;
transform values of the master clock time to respective frames of reference of respective ones of the plurality of VMs based on respective ones of the transformations; and
perform time measurement dialogues with the plurality of VFs including measurement messages exchanged by the responder device and the peripheral device, the measurement messages including translated values of the master clock time in the respective frames of reference.

24. The system according to claim 23, wherein the processing circuitry is to select from the plurality of transformations between the master clock time and the respective virtual counter values of the plurality of VMs based on data included in requests received from the VFs.

25. The system according to claim 23, wherein the data included in the requests includes VF-specific requester identifications (IDs).

26. The system according to claim 25, wherein the VFs are to generate the requests with the VF-specific requester IDs.

27. The system according to claim 23, wherein the host device includes a central processing unit (CPU) to run a hypervisor to manage the VM, the hypervisor being to configure the responder device to apply the transformations to given values of the master clock time according to the VFs requesting time responses.

28. The system according to claim 15, wherein the transformation includes a constant addition/subtraction factor and a constant multiplication/division factor.

29. A method, comprising:
sharing data with a peripheral device over a data communication bus between a host device and a peripheral device;
transforming values of a master clock time maintained by the host device to a frame of reference of a virtual machine (VM) executed by the host device based on a transformation between the master clock time and a virtual counter value of the VM; and
performing a time measurement dialogue with a VF associated with the VM, the VF being executed by the peripheral device, the time measurement dialogue including measurement messages exchanged by a responder device and the peripheral device, the measurement messages including translated values of the master clock time in the frame of reference of the VM.
